(19) United States
(12) Patent Application Publication
(10) Pub. No.: US 2024/0051409 A1
(43) Pub. Date: Feb. 15, 2024

(54) LOCKING DEVICE FOR ELECTRIC VEHICLE AND SMART INLET FOR ELECTRIC VEHICLE HAVING SAME

(71) Applicant: Dgenx co., ltd., Asan-si (KR)

(72) Inventors: In Guk KIM, Sejong-si (KR); Hee Jin KIM, Cheonan-si (KR); Sung Dong WOO, Cheonan-si (KR); Heung Il KIM, Yongin-si (KR); Seung Cheol JEONG, Asan-si (KR); Jong Il KIM, Cheonan-si (KR)

(21) Appl. No.: 18/184,277

(22) Filed: Mar. 15, 2023

(30) Foreign Application Priority Data
Aug. 9, 2022 (KR) 10-2022-0099148

(51) Int. Cl. B60L 53/16; B60L 53/30

(52) U.S. Cl. CPC B60L 53/16; B60L 53/30

(57) ABSTRACT

A locking device for an electric vehicle is configured to maintain an electrical connection state between an outlet module and an inlet module with an automatic locking module that maintains or releases the electrical connection state between the outlet module and the inlet module by pulling a hook block with respect to the electric vehicle according to whether an outlet unit is coupled on the basis of an inlet unit or by pushing the hook block with respect to the electric vehicle.

### CROSS-REFERENCE TO RELATED APPLICATION

The present application claims priority to Korean Patent Application No. 10-2022-0099148, filed Aug. 9, 2022, which is incorporated herein by reference in its entirety.

### BACKGROUND

### 1. Field of the Invention

The present disclosure relates to a locking device for an electric vehicle and a smart inlet for the electric vehicle having the locking device configured to automatically couple and fix an outlet unit to an inlet unit for charging the electric vehicle when the electric vehicle is charged, the locking device being also configured to prevent the outlet unit from being arbitrarily separated from the inlet unit during charging of the electric vehicle, and the locking device being configured to separate the outlet unit from the inlet unit manually by using a smart key of the corresponding electric vehicle in an emergency situation during charging of the electric vehicle.

### 2. Description of the Related Art

Generally, a charging connector is provided on an end portion of a charging gun that is connected to a charger installed at a vehicle electric charging station, and the charging connector provided on the charging gun is inserted into and fastened to an inlet of a charging socket provided in an electric vehicle, thereby charging a battery of the electric vehicle.

In this manner, when the charging of the battery of the electric vehicle is performed by connecting the charging connector to the inlet, the charging of the battery takes a long time compared to the time required for gasoline refueling of an internal combustion engine vehicle. For example, according to the charger, at least three to four hours may be required as a charging time.

Accordingly, when a user inserts and fastens the charging connector to the charging socket of the electric vehicle and then the charging is started, the user leaves the vehicle (that is, the electric vehicle or a hybrid vehicle) as it is, and then the user moves to another location and performs another work and then returns to a location where the vehicle exists at the time when the charging is completed. Therefore, while the user does not exist near the vehicle, there is a possibility that the charging connector is separated from the charging socket for any reason or the charging connector is stolen.

### SUMMARY

Accordingly, the present disclosure has been made keeping in mind the above problems occurring in the related art, and an objective of the present disclosure is to provide a locking device for an electric vehicle and a smart inlet for the electric vehicle having the locking device configured to automatically couple and fix an outlet unit to an inlet unit for charging the electric vehicle when the electric vehicle is charged, the locking device being also configured to prevent the outlet unit from being arbitrarily separated from the inlet unit during charging of the electric vehicle, and the locking device being configured to separate the outlet unit from the inlet unit manually by using a smart key of the corresponding electric vehicle in an emergency situation during charging of the electric vehicle.

According to an exemplary embodiment of the present disclosure, there is provided a locking device for an electric vehicle, the locking device being configured to maintain an electrical connection state between an outlet module and an inlet module when the outlet module of an outlet unit to which a hook block is rotatably coupled and the inlet module of an inlet unit provided in the electric vehicle are electrically connected to each other, and the locking device including: an automatic locking module configured to maintain the electrical connection state between the outlet module and the inlet module by pulling the hook block with respect to the electric vehicle according to whether the outlet unit is coupled on the basis of the inlet unit, or release the electrical connection state between the outlet module and the inlet module by pushing the hook block with respect to the electric vehicle.

Here, the automatic locking module may include: a clasp block coupled to an inlet body provided in the inlet unit such that the clasp block is capable of being slidably moved, the clasp block being engaged with the hook block; an operating gear coupled to the inlet body via an operating shaft such that the operating gear is capable of being rotated, the operating gear being engaged with the clasp block; and an operating driving member configured to rotate the operating gear in forward and reverse directions.

Here, the clasp block may include: a clasp body coupled to the inlet body such that the clasp body is capable of being slidably moved; an operating groove portion which is recessively formed on a first side of the clasp body and into which the operating gear is rotatably inserted when the clasp body is slidably moved in the inlet body; an operating rack gear provided on the operating groove portion and engaged with a pinion gear; a protrusion body which protrudes on a second side of the clasp body and on which the hook block is seated; and a clasp hook provided on an end portion of the protrusion body, the clasp hook being capable of being engaged with the hook block.

Here, a fixing protrusion portion may protrude from the inlet body, the fixing protrusion portion being spaced apart from the clasp block so as to cover a part of the hook block as the electric connection between the outlet module and the inlet module is completed.

At this time, the fixing protrusion portion may limit a pivot movement of the hook block.

Here, the automatic locking module may further include an interlocking slider coupled to the clasp block such that the interlocking slider is capable of being slidably moved, the interlocking slider being capable of covering a part of the hook block that is engaged with the clasp block, the clasp block may further include an interlocking guide hole portion which is in communication with the operating groove portion and to which the interlocking slider is coupled such that the interlocking slider is capable of being slidably moved, and the interlocking slider may include an interlocking rack gear with which the operating gear provided in the operating groove portion is engaged.

The locking device for the electric vehicle according to the present disclosure may further include a control member configured to control an operation of the operating driving member according to whether the outlet unit is coupled on the basis of the inlet unit.

Here, the control member may include: a control detection portion which is provided in the inlet body and which is configured to generate a hook signal by detecting the outlet unit; and a driving control unit configured to control an operation of the operating driving member according to the hook signal.

According to an exemplary embodiment of the present disclosure, the locking device for the electric vehicle may further include an emergency locking module to which a spare key provided in a smart key of the electric vehicle is coupled and which is configured to operate the automatic locking module according to an operation of the spare key.

Here, the emergency locking module may include: an emergency coupling portion spaced apart from the inlet module and provided in the inlet body; a bevel rod coupled to the emergency coupling portion such that the bevel rod is capable of being rotated and slidably moved; a reciprocating bevel gear coupled to a first end portion of the bevel rod; a driving bevel gear coupled to the operating shaft such that the driving bevel gear is capable of being detachably engaged with the reciprocating bevel gear, the driving bevel gear being configured to be rotated together with the operating shaft; and an operation head which is coupled to a second end portion of the bevel rod and to which the spare key is capable of being detachably coupled.

Here, the emergency locking module may further include a reciprocating elastic member elastically pressing the bevel rod toward the operation head with respect to the emergency coupling portion.

Here, the emergency locking module may further include an emergency motor provided on an end portion of the bevel rod, the emergency motor being configured to rotate the reciprocating bevel gear in the forward and reverse directions according to a rotation direction of the bevel rod.

According to the present disclosure, there is provided a smart inlet for an electric vehicle, the smart inlet being electrically connected to an outlet module of an outlet unit to which a hook block is rotatably coupled, and the smart inlet including: an inlet body coupled to the electric vehicle; an inlet module provided in the inlet body and electrically connected to the outlet module; and a locking module configured to maintain an electrical connection state between the outlet module and the inlet module when the outlet module and the inlet module are electrically connected to each other, in which the locking module includes the locking device for the electric vehicle according to an embodiment of the present disclosure.

According to the present disclosure, when the electric vehicle is charged via the automatic locking module, the outlet unit is automatically coupled and fixed to the inlet unit so as to charge the electric vehicle, and the outlet unit is capable of being prevented from being separated from the inlet unit in an emergency situation during the charging of the electric vehicle. In addition, during the charging of the electric vehicle, when the smart key of the corresponding electric vehicle is used, the outlet unit is capable of being separated from or coupled to each other manually by the emergency locking module.

In addition, by a detailed coupling relationship of the automatic locking module, whether the clasp block and the hook block are engaged with each other is capable of being determined by slidably moving the clasp block according to the operation of the operating driving member.

In addition, by a detailed coupling relationship of the clasp block, the slide movement of the clasp body in the inlet body may be smoothly performed, and the engagement between the operating gear and the operating rack gear may be secured.

In addition, by a detailed coupling relationship of the fixing protrusion portion, the pivot movement of the hook block in a state in which the electrical connection between the outlet module and the inlet module is maintained is capable of being prevented, and the outlet unit is capable of being prevented from being arbitrarily separated from the inlet unit.

In addition, by a detailed relationship of the interlocking slider, since a simultaneous movement of the clasp block and the interlocking slider is realized as one operating driving member operates one operating gear, the hook block is capable of being stably restrained in the clasp block or the hook block is capable of being easily released from being restrained in the clasp block. In addition, a structure in which the clasp body and the interlocking slider are slid in the opposite directions to each other is capable of being secured. In addition, the engagement of the operating gear and the interlocking rack gear engaged with the operating rack gear in the operating groove portion is capable of being secured.

In addition, by a coupling relationship of the control member, the coupling between the clasp block and the hook block is stably detected, so that the operation of the operating driving member is capable of being stably controlled.

In addition, by a detailed coupling relationship of the emergency locking module, the automatic locking module is capable of being operated by the spare key that is provided in the smart key, and the outlet unit is capable of being separated from the inlet unit in an emergency situation.

In addition, by a coupling relationship of the reciprocating elastic member, the reciprocating bevel gear and the driving bevel gear are capable of being separated from each other when the automatic locking module is operated, and the reciprocating bevel gear and the driving bevel gear are capable of being coupled to each other when the emergency locking module is operated.

In addition, when the emergency motor is omitted, the driving bevel gear engaged with the reciprocating bevel gear is capable of being rotated by rotating the spare key in the forward and reverse directions, the spare key being provided in the smart key. In addition, when the emergency motor is provided, the driving bevel gear engaged with the reciprocating bevel gear is capable of being rotated by only the pivot movement of the spare key in the forward and reverse directions, the spare key being provided in the smart key.

In addition, by a detailed relationship between the inlet unit and the outlet unit, the coupling between the inlet unit and the outlet unit is capable of being stably maintained during charging of the electric vehicle.

In addition, the slide movement of the clasp block in the inlet body is capable of being smoothly performed.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 and FIG. 2 are perspective views illustrating a smart inlet for an electric vehicle according to an embodiment of the present disclosure;

FIG. 3 is a front view illustrating the smart inlet for the electric vehicle according to an embodiment of the present disclosure;

FIG. 4 is a perspective view illustrating a clasp block included in an automatic locking module in the smart inlet for the electric vehicle according to an embodiment of the present disclosure;

FIG. 5 is an enlarged cross-sectional view illustrating a main portion that shows a coupling relationship of the automatic locking module in the smart inlet for the electric vehicle according to an embodiment of the present disclosure;

FIG. 6 is a transverse cross-sectional view illustrating a coupling relationship between the automatic locking module and a manual locking module in the smart inlet for the electric vehicle according to an embodiment of the present disclosure; and

FIG. 7 is a partial cross-sectional view illustrating a coupling relationship between the clasp block and a guide member of the automatic locking module in the smart inlet for the electric vehicle according to an embodiment of the present disclosure.

### DETAILED DESCRIPTION

The above and other objectives, features, and advantages of the present disclosure will be more clearly understood from the embodiments below when taken in conjunction with the accompanying drawings. However, the present disclosure is not limited to the embodiments described herein and may be embodied in other forms. The embodiments described herein are presented to form a complete disclosure of the present disclosure and to help those of ordinary skill in the art best understand the disclosure.

It will be understood that when an element is referred to as being on another element, the element can be directly on another element or intervening elements may be present. In addition, in the drawings, thicknesses of elements are exaggerated for effective description of the technical details.

If the terms such as first and second are used to describe elements, these elements should not be limited by such terms. These terms are used for the purpose of distinguishing one element from another element only. The exemplary embodiments include their complementary embodiments.

Also, it will be understood that when a first element (or first component) is referred to as being operated or executed on a second element (or second component), the first element (or first component) can be operated or executed in an environment where the second element (second component) is operated or executed or can be operated or executed by interacting with the second element (second component) directly or indirectly.

Also, it will be understood that when an element, a component, an apparatus, or a system is referred to as including a component consisting of a program or software, the element, the component, the apparatus, or the system can include hardware (for example, a memory or a central processing unit (CPU)) or other programs or software (for example, an operating system (OS) or a driver necessary for driving hardware), unless the context clearly indicates otherwise.

In addition, it will be understood that an element (or component) may be implemented in software, hardware, or in any form of software and hardware, unless the context clearly indicates otherwise.

The terms used herein are for the purpose of describing particular exemplary embodiments only and are not intended to limit the scope of the present disclosure. As used herein, the singular forms are intended to include the plural forms as well, unless the context clearly indicates otherwise. It will be further understood that the terms ‘comprises’ and/or ‘comprising’ used herein do not preclude the presence or addition of one or more other components.

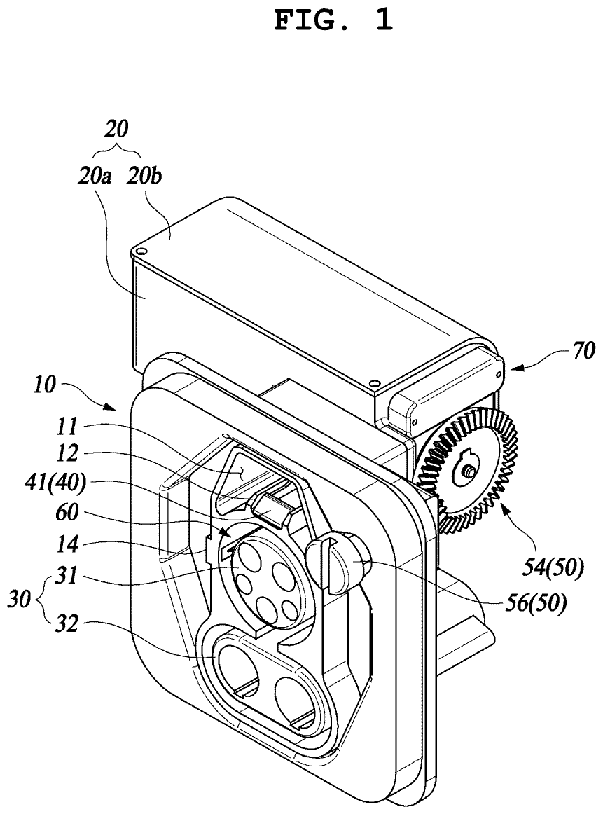

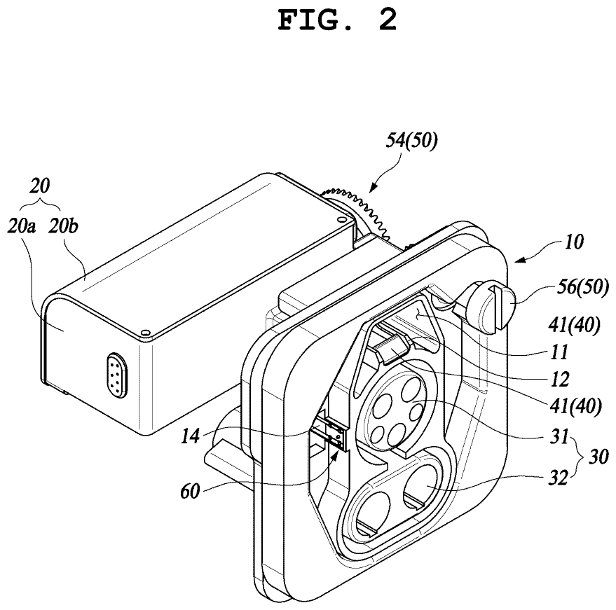

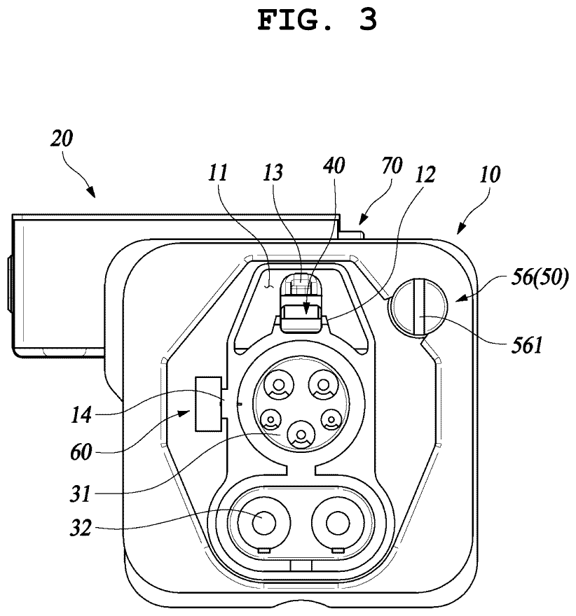

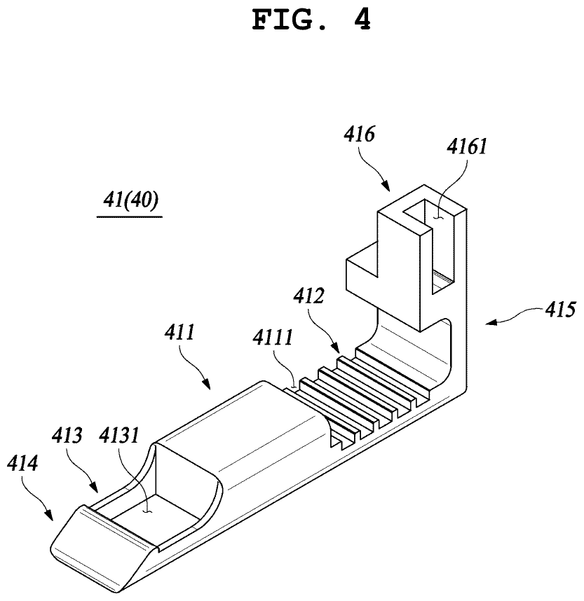

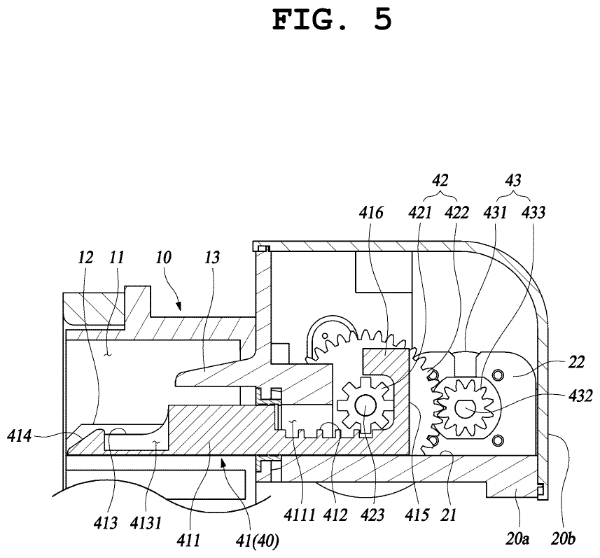

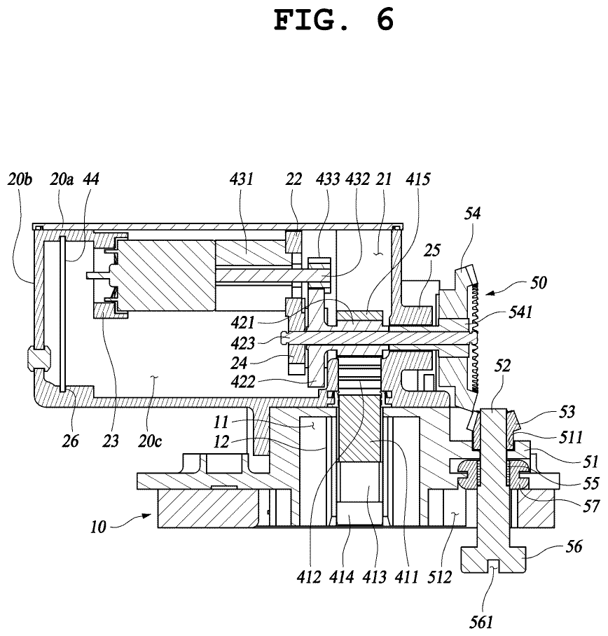

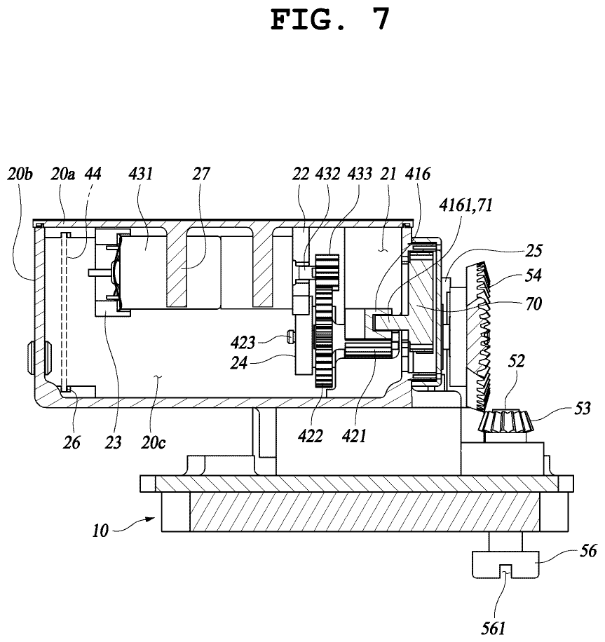

Referring to FIGS. 1 to 7, a smart inlet for an electric vehicle according to an embodiment of the present disclosure may include an inlet unit that is connected to an outlet unit.

The outlet unit may include an outlet body, a holding body, an outlet module, a hook block, and a catching elastic member.

The outlet body is coupled to a charging cable that is connected to a charging station for supplying a power. The outlet body may include a body groove portion that forms a space to which the hook block is coupled, and may include a body elastic supporting portion provided at the body groove portion so as to support the catching elastic member. The outlet body may be provided with a button supporting portion which is in communication with the body groove portion and to which a release button that is provided at the hook block is coupled.

The holding body protrudes from the outlet body. A user is capable of holding the holding body.

The outlet module protrudes from the outlet body, and is connected to the charging cable. The outlet module is electrically connected to an inlet module 30 as the outlet module is fitted and coupled to the inlet module 30 of the inlet unit that will be described later. The outlet module may be divided into a first outlet member that is for slow charging and a second outlet member that is for quick charging.

The hook block is rotatably inserted into the body groove portion so that a first end portion of the hook block is exposed to the outside of the body groove portion. The hook block may include a pivot rod rotatably coupled to the outlet body via a hook shaft portion while the first end portion of the hook block is inserted into the body groove portion so that the first end portion of the hook block is exposed to the outside of the body groove portion, a block hook provided at a first end portion of a pivot rod that is exposed to the outside of the body groove portion, and the release button that is provided at a second end portion of the pivot rod. The pivot rod extends to both sides thereof with respect to the hook shaft portion. The pivot rod may include a hook elastic supporting portion so as to support the catching elastic member. The block hook is configured to be engaged with a clasp hook 414 of a locking module provided at the inlet unit. The release button is provided at the button supporting portion, and may protrude to the outside of the outlet body.

The catching elastic member elastically supports the hook block with respect to the outlet body. When the hook block is seated on a clasp block 41 of the locking module that is provided at the inlet unit, the catching elastic member is capable of maintaining a stable seating state of the hook block in the clasp block 41.

The inlet unit is electrically connected to the outlet module of the outlet unit to which the hook block is rotatably coupled. The inlet unit may include an inlet body, the inlet module 30, and the locking module, and may further include a guide member 70.

The inlet body is coupled to an electric vehicle. The inlet body may be divided into a body housing 10 in which the inlet module 30 is provided and a driving housing 20 in which a part of the locking module is provided.

In the body housing 10 of the inlet body, a block groove portion 11 to which the clasp block 41 in the locking module is slidably fitted and coupled and to which the hook block is detachably fitted and coupled may be recessively formed.

In the body housing 10 of the inlet body, a block guide 12 which is provided at the block groove portion 11 and to which the clasp block 41 is slidably coupled may be provided.

In the body housing 10 of the inlet body, a fixing protrusion portion 13 may protrude to be spaced apart from the clasp block 41 so as to cover a part of the hook block as an electric connection between the outlet module and the inlet module 30 is completed. The clasp block 41 protrudes on an inner side surface of the block groove portion 11. As the fixing protrusion portion 13 covers the part of the hook block, a pivot movement of the hook block is limited. When the fixing protrusion portion 13 is omitted, an interlocking slider that will be described later may be provided. Conversely, when the interlocking slider is omitted, the fixing protrusion portion 13 may be provided.

In the body housing 10 of the inlet body, a sensor coupling portion 14 corresponding to an edge of the inlet module 30 may be provided. A detection sensor 60 in a control detection portion is coupled to the sensor coupling portion 14. The sensor coupling portion 14 formed long in correspondence with a slide movement direction of the clasp block 41. Here, it is illustrated that the detection sensor 60 is coupled to a front side portion of the sensor coupling portion 14 in correspondence with an inlet of the inlet module 30, but there is no limitation, and a position of the detection sensor 60 in the sensor coupling portion 14 is capable of variously adjusted. Particularly, when the detection sensor 60 is coupled to a rear side portion of the sensor coupling portion 14, exposure of the detection sensor 60 to the outside is minimized, foreign substances from the outside are inhibited or prevented from contacting the detection sensor 60, and sensitivity of the detection sensor 60 is capable of being prevented from being lowered.

The driving housing 20 of the inlet body may include a driving body 20a that forms a driving space 20c, and may include a driving cover 20b opening and closing the driving space 20c.

In the driving housing 20 of the inlet body, the driving body 20a may be provided with a driving guide 21 which is in communication with the block guide 12 and to which the clasp block 41 is slidably coupled.

In the driving housing 20 of the inlet body, the driving body 20a may be at least provided with a motor bracket 22 among the motor bracket 22 and a support bracket 23, the motor bracket 22 supporting a first side of a driving motor 431 of the locking module and the support bracket 23 supporting a second side of the driving motor 431. A driving shaft 432 of the driving motor 431 may be rotatably coupled to the motor bracket 22.

In the driving housing 20 of the inlet body, the driving body 20a may be at least provided with a gear bracket 24 among the gear bracket 24 and a bevel supporting portion 25, in which the gear bracket 24 is where an operating gear 42 of the locking module is rotatably coupled and the bevel supporting portion 25 is where a driving bevel gear 54 of an emergency locking module 50 is rotatably coupled. An operating shaft 423 of the operating gear 42 may be rotatably coupled to the gear bracket 24. The operating shaft 423 of the operating gear 42 or a driving bevel shaft of the driving bevel gear 54 may be rotatably coupled to the bevel supporting portion 25.

In the drive housing 20 of the inlet body, a control coupling portion 26 to which a control member 44 of an automatic locking module 40 is detachably coupled may be provided at the driving body 20a.

In the drive housing 20 of the inlet body, a motor supporting portion 27 supporting the driving motor 431 of an operating driving member 43 of the automatic locking module 40 is provided in the driving cover 20b, so that the driving motor 431 is capable of being positioned at a correct position in the driving housing 20.

The inlet module 30 is provided in the inlet body. The inlet module 30 is electrically connected to the outlet module as the inlet module 30 is fitted and coupled to the outlet module. The outlet module may be divided into a first inlet member 31 that is connected to the first outlet member for slow charging and a second inlet member 32 that is connected to the second outlet member for quick charging. The first inlet member 31 is disposed in the body housing 10 of the inlet body such that the first inlet member 31 is adjacent to the clasp block 41 of the automatic locking module 40, and the second inlet member 32 is disposed in the body housing 10 of the inlet body such that the second inlet member 32 is spaced apart from the first inlet member 31 and is spaced apart from the clasp block 41.

When the outlet module is electrically connected to the inlet module 30, the locking module maintains an electrical connection state between the outlet module and the inlet module 30. The locking module includes a locking device for an electric vehicle according to an embodiment of the present disclosure. The locking device for the electric vehicle according to an embodiment of the present disclosure includes the automatic locking module 40, and may further include the emergency locking module 50.

The automatic locking module 40 maintains the electrical connection state between the outlet module and the inlet module 30 by pulling the hook block with respect to the electric vehicle according to whether the outlet unit is coupled on the basis of the inlet unit, or releases the electrical connection state between the outlet module and the inlet module 30 by pushing the hook block with respect to the electric vehicle.

The automatic locking module 40 may include the clasp block 41 which is slidably coupled to the inlet body provided in the inlet unit and which is engaged with the hook block, the operating gear 42 which is rotatably coupled to the inlet body via the operating shaft 423 and which is engaged with the clasp block 41, and the operating driving member 43 rotating the operating gear 42 in forward and reverse directions.

The clasp block 41 may include a clasp body 411 slidably coupled to the inlet body, an operating groove portion 4111 which is recessively formed on a first side of the clasp body 411 and into which the operating gear 42 is rotatably inserted when the clasp body 411 is slid in the inlet body, an operating rack gear 412 provided on the operating groove portion 4111 and engaged with a pinion gear 421, a protrusion body 413 which protrudes on a second side of the clasp body 411 and on which the hook block is seated, and a clasp hook 414 which is provided on an end portion of the protrusion body 413 and which is capable of being engaged with the hook block. A seating groove portion 4131 on which the block hook of the hook block is seated may be provided in the protrusion body 413. The operating gear 42 includes the pinion gear 421 engaged with the operating rack gear 412, and may further include a transmission gear 422 which is coaxially coupled to the pinion gear 421 and engaged with a driving gear 433 of the operating diving member 43. The operating driving member 43 includes the driving motor 431 configured to generate a driving force for rotating the operating gear 42 in the forward and reverse directions, and may further include the driving shaft 432 configured to be rotated by the driving force and the driving gear 433 which is coupled to the driving shaft 432 and rotated together with the driving shaft 432 and which is engaged with the transmission gear 422 of the operating gear 42.

The clasp block 41 may further include a stop body 415 which protrudes on a first end portion of the clasp body 411 and which limits a movement of the operating gear 42, and may further include a guide coupling member 416 which protrudes on the stop body 415 so as to be coupled to the guide member 70. A coupling groove portion 4161 to which a guide protrusion portion 71 provided in the guide member 70 is fitted and coupled may be provided in the guide coupling member 416.

The automatic locking module 40 may further include the control member 44 configured to control a movement of the operating driving member 43 according to whether the outlet unit is coupled on the basis of the inlet unit.

The control member 44 may include the control detection portion which is provided in the inlet body and which is configured to detect the outlet unit and generate a hook signal, and may include the driving control unit configured to control the movement of the operating driving member 43 according to the hook signal. The control detection portion may include at least one of a charging detection portion, a seating detection portion, a catching detection portion, and the detection sensor 60, the charging detection portion being provided on the clasp body 411 and being configured to detect the block hook of the hook block, the seating detection portion being provided on the protrusion body 413 of the clasp block 41 and being configured to detect the block hook of the hook block, the catching detection portion being provided on the clasp hook 414 of the clasp block 41 and being configured to detect the block hook of the hook block, the detection sensor 60 being provided on the sensor coupling portion 14 provided on the body housing 10 of the inlet body and being configured to detect the outlet module.

The control member 44 may further include a communication unit configured to transmit a control signal of the driving control unit in a wireless manner. The control signal is transmitted to a mobile device or a smart key of the electric vehicle, so that a charging state of the electric vehicle is capable of being checked on the mobile device or the smart key of the electric vehicle. In addition, the communication unit receives a release signal transmitted from the mobile device or the smart key of the electric vehicle, so that the control member 44 is capable of slidably moving the clasp block 41 so as to separate the hook block.

Although not illustrated, the automatic locking module 40 may further include the interlocking slider which is slidably coupled to the clasp block 41 and which is capable of covering a part of the hook block that is engaged with the clasp block 41. Therefore, the clasp block 41 may further include an interlocking guide hole portion which is in communication with the operating groove portion 4111 and to which the interlocking slider is capable of being slidably coupled. An interlocking rack gear with which the pinion gear 421 of the operating gear 42 that is provided on the operating groove portion 4111 may be provided on the interlocking slider.

Then, since the clasp block 41 and the interlocking slider are slidably moved in opposite directions to each other at the same time by a single action that is a rotation of the operating gear 42, the interlocking slider protrudes toward the protrusion body 413 and covers the part of the hook block as the electrical connection between the outlet module and the inlet module 30 is completed, and a pivot movement of the hook block is limited.

Accordingly, in a state in which the electric vehicle is charged, the hook block is prevented from being separated from the clasp block 41 as the interlocking slider protrudes with respect to the inlet body and covers the block hook of the hook block that is seated on the protrusion body 413. Furthermore, in a state in which the charging of the electric vehicle is completed or the charging of the electric vehicle is stopped, the hook block 240 is capable of being easily separated from the locking module as the interlocking slider is inserted with respect to the inlet body and the covering of the block hook of the hook block that is seated on the protrusion body 413 is released.

A spare key provided in the smart key of the electric vehicle is coupled to the emergency locking module 50, and the emergency locking module 50 is configured to operate the automatic locking module 40 according to an operation of the spare key.

The emergency locking module 50 may include an emergency coupling portion 51 spaced apart from the inlet module 30 and provided in the inlet body, a bevel rod 52 rotatably and slidably coupled to the emergency coupling portion 51, reciprocating bevel gear 53 coupled to a first end portion of the bevel rod 52, the driving bevel gear 54 which is coupled to the operating shaft 423 such that the bevel gear 54 is detachably engaged with the reciprocating bevel gear 53 and which is capable of being rotated together with the operating shaft 423, and an operation head 56 which is coupled to a second end portion of the bevel rod 52 and to which the spare key is detachably coupled.

The emergency coupling portion 51 may be provided with a bevel seating portion 512 on which the reciprocating bevel gear 53 is seated in an idle state. The emergency coupling portion 51 may be provided with an operation exposure portion 511 that forms a space where the operation head 56 moves.

The driving bevel gear 54 may be coaxially coupled to the operating shaft 423 via the driving bevel shaft.

The operation head 56 may be provided with a key coupling portion 561 to which the spare key is fitted and coupled. The key coupling portion 561 is provided with a key fitting bundle to which the spare key is coupled so that only the corresponding spare key is capable of being fitted and coupled, so that only the corresponding key is coupled to the operation head 56 and the slide movement and the rotation of the operation head 56 are capable of being realized.

Then, in the idle state in which the reciprocating bevel gear 53 and the driving bevel gear 54 are separated from each other, when the bevel rod 52 is inserted according to the operation of the operation head 56, the reciprocating bevel gear 53 and the driving bevel gear 54 are engaged with each other.

Since the emergency locking module 50 further includes a reciprocating elastic member 55 that elastically presses the bevel rod 52 toward the operation head 56 with respect to the emergency coupling portion 51, the idle state of the emergency locking module 50 is stably maintained. Furthermore, when an external force applied to the operation head 56 is released, the emergency locking module 50 is returned to the idle state.

The emergency locking module 50 further includes a rod guide 57 coupled to the emergency coupled portion 51 so that the bevel rod 52 is capable of being rotated and slid, so that the bevel rod 52 is stably protected in response to the movement of the bevel rod 52.

Although not illustrated, the emergency locking module 50 may further include an emergency motor which is provided on an end portion of the bevel rod 52 and which is configured to rotate the reciprocating bevel gear 53 in the forward and reverse directions according to a rotation direction of the bevel rod 52. Therefore, since the emergency motor is operated by only the forward and reverse pivot movements of the operation head 56 while the bevel rod 52 is inserted with respect to the emergency coupling portion 51 and the reciprocating bevel gear 53 and the driving bevel gear 54 are engaged with each other, the reciprocating bevel gear 53 is capable of being automatically rotated in the emergency locking module 50.

The guide member 70 is provided in the driving housing 20 of the inlet body. In the automatic locking module 40, the guide member 70 is configured to detect a slide movement state of the clasp block 41. The guide member 70 is fitted and coupled to the coupling groove portion 4161 provided in the guide coupling member 416 of the clasp block 41, so that the guide member 70 is capable of being slid together with the clasp block 41. The guide member 70 may be utilized as one of the control detection portions described above.

In describing an operating of the smart inlet for the electric vehicle according to an embodiment of the present disclosure, when the electric vehicle is required to be charged, the outlet module is electrically connected to the inlet module 30. Then, the block hook is seated on the protrusion body 413. At this time, by pressing and then releasing the release button, the block hook is capable of being seated on the protrusion body 413.

When the block hook is seated on the protrusion body 413, the operating driving member 43 is operated by the hook signal that is generated from the control detection portion, so that the clasp block 41 is inserted into the block groove portion 11 as the operating gear 42 is rotated. At this time, the interlocking slider may protrude toward the outlet unit.

Therefore, in a state in which the block hook is seated on the protrusion body 413, the fixing protrusion portion 13 or the interlocking slider covers the block hook. At this time, since the guide member 70 detects the insertion of the clasp block 41 and the driving control unit stops the operating driving member 43 by a stop signal, the fixing protrusion portion 13 or the interlocking slider is capable of maintaining the cover state of the block hook.

In addition, the operating driving member 43 is capable of additionally rotating the operating gear 42 by a predetermined rotation amount by an additional connection signal, and the clasp block 41 pulls the hook block, so that the electrical connection between the inlet module 30 and the outlet module is capable of being secured.

When the outlet unit is pulled in a state in which the electric vehicle is charged, the outlet unit is not separated from the inlet unit.

When the charging of the electric vehicle is completed, the user wants to stop the charging of the electric vehicle, or the charging of the electric vehicle is stopped, a release signal is transmitted to the control member 44 when the user operates the mobile device or the smart key of the electric vehicle.

Here, by the release signal, the charging station may block the supplied power.

In addition, the driving control unit operates the operating driving member 43 and the operating gear 42 is rotated in the reverse direction, the clasp block 41 protrudes toward an initial position. Accordingly, the cover of the block hook by the fixing protrusion portion 13 or the interlocking slider is released. As the protrusion of the clasp block 41 is completed, the guide member 70 detects the initial position of the clasp block 41, and the driving control unit may stop the operating driving member 43 by a stop signal generated from the guide member 70.

Then, by separating the outlet module from the inlet module 30 while the release button is pressed, the outlet unit is capable of being easily separated from the inlet unit.

Here, when the electrical connection between the outlet module and the inlet module 30 is not realized during charging of the electric vehicle, or when the outlet unit is required to be separated from the inlet unit during charging of the electric vehicle, the outlet module is capable of being separated from the inlet module 30 by operating the emergency locking module 50.

First, the spare key provided in the smart key is coupled to the key coupling portion 561 of the operation head 56. Then, the rotation and the slide movement of the operation head 56 is capable of being determined according to whether the spare key is coupled to the key coupling portion 561.

When the spare key is not coupled to the key coupling portion 561, the operation of the operation head 56 is not capable of being performed.

When the spare key is coupled to the key coupling portion 561, the spare key presses the operation head 56 and the bevel rod 52 is inserted with respect to the inlet body according to the slide movement of the bevel rod 52, and the reciprocating bevel gear 53 is engaged with the driving bevel gear 54.

In a state in which the driving bevel gear 54 is engaged with the reciprocating bevel gear 53, when the spare key is rotated in the forward direction, the driving bevel gear 54 engaged with the reciprocating bevel gear 53 is rotated in the forward direction, and the clasp block 41 is capable of being inserted into an inner portion of the body housing 10 of the inlet body with respect to the inlet body. Conversely, when the spare key is rotated in the reverse direction, the driving bevel gear 54 engaged with the reciprocating bevel gear 53 is rotated in the reverse direction, and the clasp block 41 may protrude with respect to the inlet body.

Conversely, in a state in which the driving bevel gear 54 is engaged with the reciprocating bevel gear 53, when the spare key is rotated in the reverse direction, the driving bevel gear 54 engaged with the reciprocating bevel gear 53 is rotated in the reverse direction, and the clasp block 41 protrudes toward the initial position with respect to the inlet body.

According to the present disclosure, when the electric vehicle is charged via the automatic locking module 40, the outlet unit is automatically coupled and fixed to the inlet unit so as to charge the electric vehicle, and the outlet unit is capable of being prevented from being separated from the inlet unit in an emergency situation during the charging of the electric vehicle. In addition, during the charging of the electric vehicle, when the smart key of the corresponding electric vehicle is used, the outlet unit is capable of being separated from or coupled to each other manually by the emergency locking module 50.

In addition, by a detailed coupling relationship of the automatic locking module 40, whether the clasp block 41 and the hook block are engaged with each other is capable of being determined by slidably moving the clasp block 41 according to the operation of the operating driving member 43.

In addition, by a detailed coupling relationship of the clasp block 41, the slide movement of the clasp body 411 in the inlet body may be smoothly performed, and the engagement between the operating gear 42 and the operating rack gear 412 may be secured.

In addition, by a detailed coupling relationship of the fixing protrusion portion 13, the pivot movement of the hook block in a state in which the electrical connection between the outlet module and the inlet module 30 is maintained is capable of being prevented, and the outlet unit is capable of being prevented from being arbitrarily separated from the inlet unit.

In addition, by a detailed relationship of the interlocking slider, since a simultaneous movement of the clasp block 41 and the interlocking slider is realized as one operating driving member 43 operates one operating gear 42, the hook block is capable of being stably restrained in the clasp block 41 or the hook block is capable of being easily released from being restrained in the clasp block 41. In addition, a structure in which the clasp body 411 and the interlocking slider are slid in the opposite directions to each other is capable of being secured. In addition, the engagement of the operating gear 42 and the interlocking rack gear engaged with the operating rack gear 412 in the operating groove portion 4111 is capable of being secured.

In addition, by a coupling relationship of the control member 44, the coupling between the clasp block 41 and the hook block is stably detected, so that the operation of the operating driving member 43 is capable of being stably controlled.

In addition, by a detailed coupling relationship of the emergency locking module 50, the automatic locking module 40 is capable of being operated by the spare key that is provided in the smart key, and the outlet unit is capable of being separated from the inlet unit in an emergency situation.

In addition, by a coupling relationship of the reciprocating elastic member 55, the reciprocating bevel gear 53 and the driving bevel gear 54 are capable of being separated from each other when the automatic locking module 40 is operated, and the reciprocating bevel gear 53 and the driving bevel gear 54 are capable of being coupled to each other when the emergency locking module 50 is operated.

In addition, when the emergency motor is omitted, the driving bevel gear 54 engaged with the reciprocating bevel gear 53 is capable of being rotated by rotating the spare key in the forward and reverse directions, the spare key being provided in the smart key. In addition, when the emergency motor is provided, the driving bevel gear 54 engaged with the reciprocating bevel gear 53 is capable of being rotated by only the pivot movement of the spare key in the forward and reverse directions, the spare key being provided in the smart key.

In addition, by a detailed relationship between the inlet unit and the outlet unit, the coupling between the inlet unit and the outlet unit is capable of being stably maintained during charging of the electric vehicle.

In addition, the slide movement of the clasp block 41 in the inlet body is capable of being smoothly performed.

What is claimed is:

1. A locking device for an electric vehicle, the locking device being configured to maintain an electrical connection state between an outlet module and an inlet module when the outlet module of an outlet unit to which a hook block is rotatably coupled and the inlet module of an inlet unit provided in the electric vehicle are electrically connected to each other, and the locking device comprising:
an automatic locking module configured to maintain the electrical connection state between the outlet module and the inlet module by pulling the hook block with respect to the electric vehicle according to whether the outlet unit is coupled on the basis of the inlet unit, or release the electrical connection state between the outlet module and the inlet module by pushing the hook block with respect to the electric vehicle.

2. The locking device of claim 1, wherein the automatic locking module comprises:
a clasp block coupled to an inlet body provided in the inlet unit such that the clasp block is capable of being slidably moved, the clasp block being engaged with the hook block;
an operating gear coupled to the inlet body via an operating shaft such that the operating gear is capable of being rotated, the operating gear being engaged with the clasp block; and
an operating driving member configured to rotate the operating gear in forward and reverse directions.

3. The locking device of claim 2, wherein the clasp block comprises:
a clasp body coupled to the inlet body such that the clasp body is capable of being slidably moved;
an operating groove portion which is recessively formed on a first side of the clasp body and into which the operating gear is rotatably inserted when the clasp body is slidably moved in the inlet body;
an operating rack gear provided on the operating groove portion and engaged with a pinion gear;
a protrusion body which protrudes on a second side of the clasp body and on which the hook block is seated; and
a clasp hook provided on an end portion of the protrusion body, the clasp hook being capable of being engaged with the hook block.

4. The locking device of claim 3, wherein a fixing protrusion portion protrudes from the inlet body, the fixing protrusion portion being spaced apart from the clasp block so as to cover a part of the hook block as the electric connection between the outlet module and the inlet module is completed.

5. The locking device of claim 3, wherein the automatic locking module further comprises an interlocking slider coupled to the clasp block such that the interlocking slider is capable of being slidably moved, the interlocking slider being capable of covering a part of the hook block that is engaged with the clasp block,
wherein the clasp block further comprises an interlocking guide hole portion which is in communication with the operating groove portion and to which the interlocking slider is coupled such that the interlocking slider is capable of being slidably moved, and
wherein the interlocking slider comprises an interlocking rack gear with which the operating gear provided in the operating groove portion is engaged.

6. The locking device of claim 2, further comprising:
a control member configured to control an operation of the operating driving member according to whether the outlet unit is coupled on the basis of the inlet unit.

7. The locking device of claim 1, further comprising:
an emergency locking module to which a spare key provided in a smart key of the electric vehicle is coupled and which is configured to operate the automatic locking module according to an operation of the spare key.

8. The locking device of claim 7, wherein the emergency locking module comprises:
an emergency coupling portion spaced apart from the inlet module and provided in the inlet body;
a bevel rod coupled to the emergency coupling portion such that the bevel rod is capable of being rotated and slidably moved;
a reciprocating bevel gear coupled to a first end portion of the bevel rod;
a driving bevel gear coupled to the operating shaft such that the driving bevel gear is capable of being detachably engaged with the reciprocating bevel gear, the driving bevel gear being configured to be rotated together with the operating shaft; and
an operation head which is coupled to a second end portion of the bevel rod and to which the spare key is capable of being detachably coupled.

9. The locking device of claim 8, wherein the emergency locking module further comprises:
a reciprocating elastic member elastically pressing the bevel rod toward the operation head with respect to the emergency coupling portion.

10. The locking device of claim 8, wherein the emergency locking module further comprises:
an emergency motor provided on an end portion of the bevel rod, the emergency motor being configured to rotate the reciprocating bevel gear in the forward and reverse directions according to a rotation direction of the bevel rod.

11. A smart inlet for an electric vehicle, the smart inlet being electrically connected to an outlet module of an outlet unit to which a hook block is rotatably coupled, and the smart inlet comprising:
an inlet body coupled to the electric vehicle;
an inlet module provided in the inlet body and electrically connected to the outlet module; and
a locking module configured to maintain an electrical connection state between the outlet module and the inlet module when the outlet module and the inlet module are electrically connected to each other,
wherein the locking module comprises the locking device for the electric vehicle according to claim 1.
